(19) United States
(12) Patent Application Publication
(10) Pub. No.: US 2014/0173068 A1
(43) Pub. Date: Jun. 19, 2014

(54) Management Apparatus and Address Management Method

(71) Applicant: Toshiba Lighting & Technology Corporation, Yokosuka-shi (JP)

(72) Inventor: Nobuyuki Monma, Yokosuka-shi (JP)

(73) Assignee: TOSHIBA LIGHTING & TECHNOLOGY CORPORATION, Yokosuka-shi (JP)

(21) Appl. No.: 13/971,918

(22) Filed: Aug. 21, 2013

(30) Foreign Application Priority Data
Dec. 13, 2012 (JP) 2012-272417

(51) Int. Cl. H04L 29/12

(52) U.S. Cl. CPC H04L 61/2007
USPC 709/221

(57) ABSTRACT

A management apparatus according to an embodiment includes a storing unit, a receiving unit, a transmitting unit, and an updating unit. The storing unit stores, in association with an IP address of a node, identification information for identifying the node. The receiving unit receives a change notification for the IP address transmitted by multicast by the node. The transmitting unit transmits, when the receiving unit receives the change notification, a response request packet by multicast. The update unit updates the storing unit on the basis of a response packet transmitted from a node that responds to the response request packet transmitted by the transmitting unit.

### CROSS-REFERENCE TO RELATED APPLICATION

This application is based upon and claims the benefit of priority from Japanese Patent Application No. 2012-272417 filed on Dec. 13, 2012, the entire contents of which are incorporated herein by reference.

### FIELD

Embodiments described herein relate generally to a management apparatus and an address management method.

### BACKGROUND

In recent years, an energy management system for controlling electric appliances and the like has been spreading. As a kind of such an energy management system, a system called HEMS (Home Energy Management System) is known. For example, ECHONET Lite formulated by the ECHONET Consortium is applied to the HEMS as a standard protocol.

The ECHONET Lite is specified assuming that a lower layer is an IP (Internet Protocol) address. On the other hand, IP addresses allocated to nodes of the electric appliances and the like are likely to change. Therefore, in the ECHONET Lite, Ethernet (registered trademark, the same applies below) addresses (e.g., MAC (Media Access Control) addresses) and the like are used to identify the nodes.

However, when the IP addresses and the Ethernet addresses are managed by an address table or the like conforming to the ARP (Address Resolution Protocol) in a management apparatus that manages the node, inconsistency is likely to occur in the address table when the IP addresses change. When it is attempted to simply solve the inconsistency of the address table, a network load is likely to increase.

### BRIEF DESCRIPTION OF THE DRAWINGS

FIG. 1 is a diagram illustrating a configuration example of an energy management system according to a first embodiment;

FIG. 2 is a diagram illustrating a configuration example of a management apparatus according to the first embodiment;

FIG. 3 is a diagram illustrating an example of a lower layer address table according to the first embodiment;

FIG. 4 is a diagram illustrating an example of an upper layer address table according to the first embodiment;

FIG. 5 is a diagram illustrating examples of an entry notification packet and a search packet according to the first embodiment;

FIG. 6 is a sequence chart illustrating a processing procedure by the energy management system according to the first embodiment;

FIG. 7 is a diagram illustrating a configuration example of a management apparatus according to a second embodiment;

FIG. 8 is a diagram illustrating a processing example by an address-management control unit according to the second embodiment; and

FIG. 9 is a sequence chart illustrating a processing procedure by the management apparatus according to the second embodiment.

### DETAILED DESCRIPTION

It is an object of the present invention to prevent inconsistency from occurring in an address table without increasing a network load.

In a management apparatus 100 according to an embodiment explained below, a lower layer address table 131 stores node identification information for identifying a node 10 in association with an IP address of the node 10. A receiving unit 141 receives an entry notification packet, which is a change notification of an IP address, transmitted by multicast by the node 10. When the receiving unit 141 receives the entry notification packet, a transmitting unit 143 transmits a response request packet (e.g., a search packet explained below) by multicast. A communication unit 110, which is an updating unit, updates the lower layer address table 131 on the basis of a response packet transmitted from the node in response to the response request packet transmitted by the transmitting unit 143.

In the management apparatus 100 according to the embodiment explained below, the transmitting unit 143 transmits, by multicast, a response request packet in which information concerning the node 10 included in the entry notification packet received by the receiving unit 141 is set in a destination object.

In the embodiment explained below, when the receiving unit 141 receives the entry notification packet, a determining unit 245 determines whether another entry notification packet is already received within a predetermined time. When the determining unit 245 determines that the entry notification packet is already received within the predetermined time, the transmitting unit 143 transmits the response request packet by multicast after staying on standby until the predetermined time elapses.

In the embodiment explained below, when the determining unit 245 determines that the entry notification packet is not already received within the predetermined time, the transmitting unit 143 transmits the response request packet by multicast without staying on standby until the predetermined time elapses.

In the embodiment explained below, when the receiving unit 141 receives the entry notification packet a plurality of times within the predetermined time, the transmitting unit 143 transmits the response request packet only once after staying on standby until the predetermined time elapses.

Management apparatuses according to embodiments are explained below with reference to the drawings. In the embodiments, the same components are denoted by the same reference numerals and signs and redundant explanation is omitted.

### First Embodiment

### Configuration of an Energy Management System

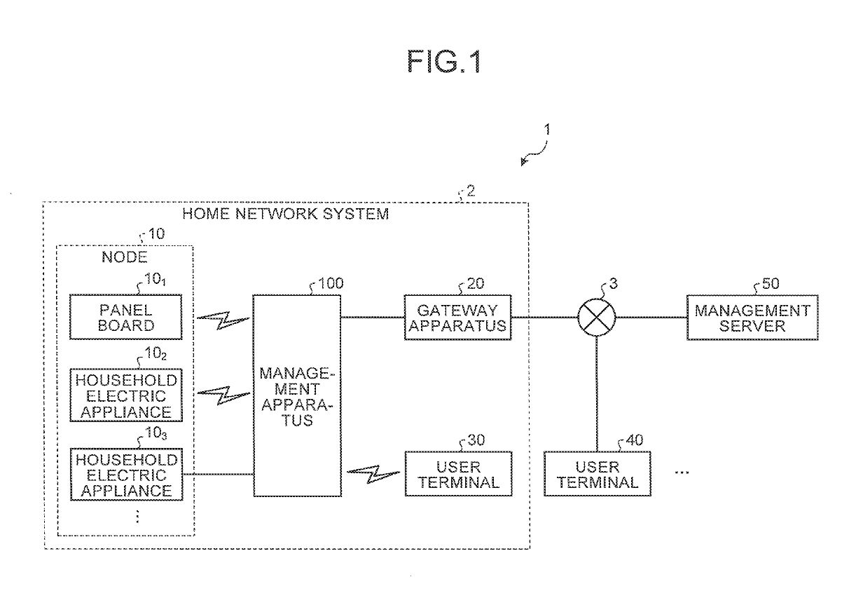

FIG. 1 is a diagram illustrating a configuration example of an energy management system 1 according to a first embodiment. The energy management system 1 illustrated in FIG. 1 is, for example, a system that realizes control and monitoring of household electric appliances and the like set in a home. The energy management system 1 is called, for example, HEMS. ECHONET Lite of the HEMS standard protocol is applied to the energy management system 1 according to the first embodiment.

The energy management system 1 includes, as illustrated in FIG. 1, a home network system 2, a user terminal 40, and a management server 50. The energy management system 1 may include a plurality of the home network systems 2 or may include a plurality of the user terminals 40 or a plurality of the management servers 50.

The home network system 2 is constructed, for example, in a user home or in a shop. The home network system 2 includes a panel board 10₁, a household electric appliance 10₂, a household electric appliance 10₃, a gateway apparatus 20, a user terminal 30, and the management apparatus 100.

The panel board 10₁ is provided, for example, on a wall of the user home. The panel board 10₁ includes various breakers and supplies electric power to the household electric appliance 10₂ and the household electric appliance 10₃. The household electric appliance 10₂ and the household electric appliance 10₃ are electric products set in the user home. For example, the household electric appliance 10₂ and the household electric appliance 10₃ correspond to a refrigerator, a television, an air conditioner, a cooking heater, a heating appliance, a water heater, an electric lock, an intercom (a door phone), a luminaire, and a washing machine. Various kinds of control, monitoring of an operation state, and the like such as “ON/OFF of a power supply” and “switching of an operation mode” for the panel board 10₁ and the household electric appliances 10₂ and 10₃ are performed by the management apparatus 100 explained below. In the following explanation, when it is unnecessary to distinguish the panel board 10₁ and the household electric appliances 10₂ and 10₃, the panel board 10₁ and the household electric appliances 10₂ and 10₃ are sometimes simply referred to as “node 10”.

The gateway apparatus 20 is a communication apparatus connected to the management apparatus 100 and configured to connect the home network system 2 to an external network 3. In the example illustrated in FIG. 1, the gateway apparatus 20 connects the management apparatus 100 in the home network system 2 and the user terminal 40 and the management server 50 on the outside of the home network system 2 via the network 3. The network 3 corresponds to, for example, the Internet or an intranet.

The user terminal 30 is, for example, a PC (Personal Computer), a cellular phone, or a PDA (Personal Data Assistance). The user terminal 30 is connected to the management apparatus 100 via a wireless LAN (Local Area Network), a cable LAN, or the like. For example, the user terminal 30 transmits a control command for the node 10 to the management apparatus 100 according to user operation. For example, the user terminal 30 displays various kinds of information concerning the node 10 received from the management apparatus 100.

The management apparatus 100 performs communication with the node 10, the gateway apparatus 20, and the user terminal 30 using a short distance radio technique such as Bluetooth (registered trademark) or a home LAN. The management apparatus 100 plays a role of an access point. For example, the management apparatus 100 transmits various control commands input from the user terminal 30 to the node 10. For example, the management apparatus 100 transmits various kinds of information received from the node 10 to the user terminal 30. The management apparatus 100 may be formed integrally with the gateway apparatus 20.

A user who uses the home network system 2 can control the node 10 via the management apparatus 100 by using the user terminal 30. For example, when the user terminal 30 is a cellular phone, the user can control the operation of the node 10 and monitor an operation state of the node 10 simply by operating the cellular phone in the home.

The user terminal 40 illustrated on the outside of the home network system 2 is, for example, a cellular phone, a PDA, or a PC. The user terminal 40 is connected to the network 3 via a wireless LAN, a cable LAN, or the like. Like the user terminal 30, the user terminal 40 transmits a control command for the node 10 to the management server 50 according to user operation and displays various kinds of information concerning the node 10 received from the management server 50.

The management server 50 transmits various control commands received from the user terminal 40 via the network 3 to the management apparatus 100. Consequently, the management apparatus 100 controls the node 10 on the basis of the control commands transmitted from the user terminal 40 located on the outside of the home network system 2. The management server 50 transmits various kinds of information concerning the node 10 received from the management apparatus 100 via the network 3 to the user terminal 40. Consequently, the user terminal 40 displays the various kinds of information concerning the node 10 set in the home network system 2. In this way, even when the user of the user terminal 40 is absent in the home network system 2, the user can control the node 10 and monitor an operation state of the node 10.

As explained above, the management apparatus 100 according to the first embodiment transmits and receives various kinds of information between the management apparatus 100 and the node 10 according to the ECHONET Lite standard. The ECHONET Lite is specified on the premise that a lower layer is an IP address. However, an IP address allocated to the node 10 is likely to change. Therefore, the management apparatus 100 specifies a communication partner node 10 using node identification information for identifying the node 10. For example, the management apparatus 100 uses a MAC address such as an Ethernet address as the node identification information. In order to prevent the node 10 from inquiring about the Ethernet address every time communication is performed, the management apparatus 100 stores, as a cache, the node identification information in an address table in association with at least the IP address. For example, the management apparatus 100 manages the IP address and the node identification information using an ARP table conforming to the ARP.

When the IP address allocated to the node 10 conforming to the ECHONET Lite changes, the node 10 transmits a packet indicating that the IP address changes (hereinafter sometimes referred to as “entry notification packet”). Consequently, the management apparatus 100 is considered to be capable of updating the address table by receiving the entry notification packet.

However, the entry notification packet is transmitted from the node 10 by multicast. Therefore, the management apparatus 100 does not update the address table even if the management apparatus 100 receives the entry notification packet to multicast. This is because the ARP specifications specify that the address table (the ARP table) is not updated when a packet to multicast is received. Therefore, an entry concerning the IP address after the change is not registered in the address table retained by the management apparatus 100. That is, even when the management apparatus 100 receives the entry notification packet, inconsistency occurs between the IP address actually allocated to the node 10 and an entry stored in the address table.

Since an application (corresponding to an application control unit 120 explained below) is based on the premise that a lower layer is an IP address, the application cannot acquire the node identification information from the entry notification packet. Further, since the IP address after the change is not registered in the address table either, the application cannot acquire, from the address table, the node identification information corresponding to the IP address set in the entry notification packet. This causes a situation in which the application cannot transmit various packets to a transmission source node of the entry notification packet.

Therefore, upon receiving the entry notification packet from the node 10, the management apparatus 100 according to the first embodiment performs processing explained below to thereby prevent inconsistency from occurring in the address table while preventing a network load from increasing. In the following explanation, it is assumed that the node identification information is an Ethernet address.

Configuration of the Management Apparatus

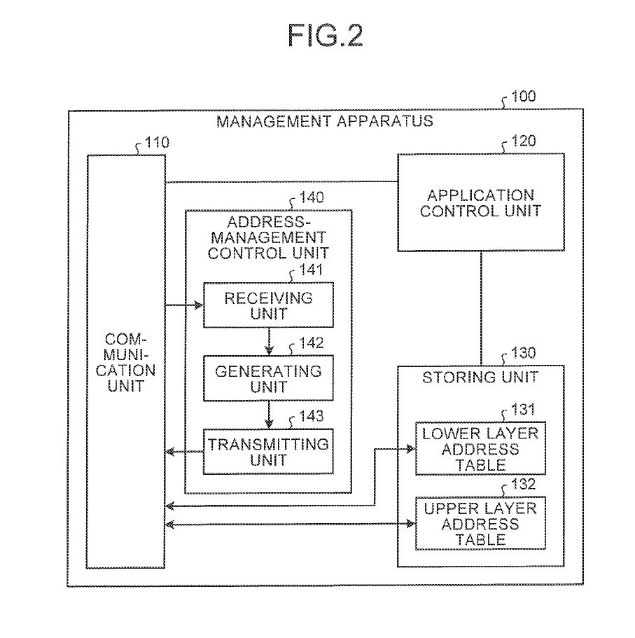

FIG. 2 is a diagram illustrating a configuration example of the management apparatus 100 according to the first embodiment. As illustrated in FIG. 2, the management apparatus 100 includes a communication unit 110, an application control unit 120, a storing unit 130, and an address-management control unit 140.

The communication unit 110 performs radio communication processing and wire communication processing. For example, the communication unit 110 transmits and receives various kinds of information by radio communication between the communication unit 110, and the panel board 10₁, the household electric appliances 10₂, and the user terminal 30 illustrated in FIG. 1. For example, the communication unit 110 transmits and receives various kinds of information by wire communication between the communication unit 110, and the household electric appliances 10₃ and the gateway apparatus 20 illustrated in FIG. 1. The communication unit 110 performs upper layer processing and lower layer processing explained below.

The application control unit 120 controls execution of a computer program for realizing remote operation processing and monitoring processing for the node 10. Specifically, the application control unit 120 executes various kinds of processing on the basis of a packet received by the communication unit 110.

The storing unit 130 is realized by a storage device such as a semiconductor memory element, for example, a RAM (Random Access Memory) or a flash memory. The storing unit 130 includes a lower layer address table 131 and an upper layer address table 132 as caches for preventing an address inquiry from being generated every time communication is performed with the node 10.

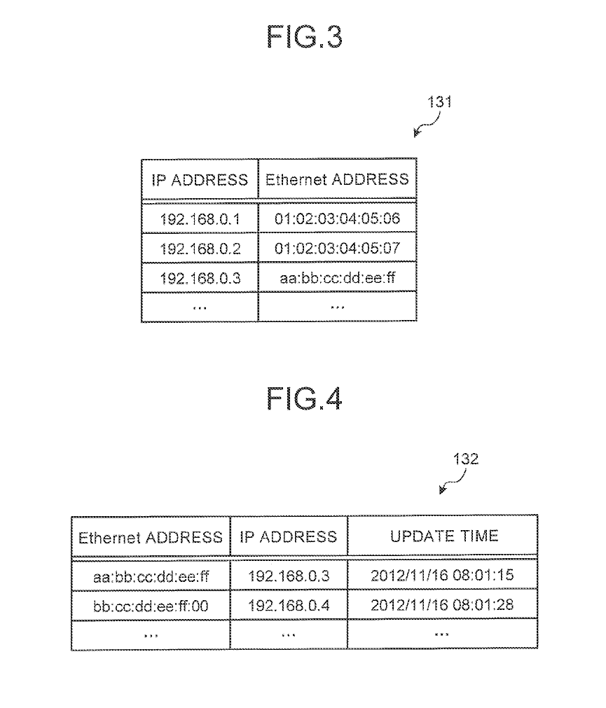

The lower layer address table 131 stores Ethernet addresses using IP addresses as keys. In FIG. 3, an example of the lower layer address table 131 according to the first embodiment is illustrated. As illustrated in FIG. 3, the lower layer address table 131 stores the Ethernet addresses in association with the IP addresses. In the lower layer address table 131 illustrated in FIG. 3, the IP addresses are unique. The lower layer address table 131 corresponds to, for example, an ARP table generated by the management apparatus 100 to which the ARP is applied. The management apparatus 100 can indirectly add an entry to the lower layer address table 131 by exchanging a packet for address solution such as the ARP between the management apparatus 100 and the node 10. An entry in the lower layer address table 131 is automatically deleted when a predetermined period (e.g., several minutes) elapses after the entry is registered.

The upper layer address table 132 stores IP addresses using Ethernet addresses as keys. In FIG. 4, an example of the upper layer address table 132 is illustrated. As illustrated in FIG. 4, the upper layer address table 132 stores IP addresses and update times in association with the Ethernet addresses. The update times indicate times when entries are registered in the upper layer address table 132. In the upper layer address table 132 illustrated in FIG. 4, the Ethernet addresses are unique.

The upper layer address table 132 is generated from the lower layer address table 131 by the communication unit 110 or the like. For example, in transmitting a packet, when the communication unit 110 acquires an Ethernet address corresponding to an IP address from the lower layer address table 131, the communication unit 110 stores a set of the Ethernet address and the IP address in the upper layer address table 132. An entry in the upper layer address table 132 is automatically deleted when a predetermined period (e.g., several minutes) elapses after the entry is registered. In general, the predetermined period for deleting an entry from the upper layer address table 132 is longer than the predetermined period for deleting an entry from the lower layer address table 131.

When the communication unit 110 receives a packet from the outside of the management apparatus 100, the communication unit 110 performs upper layer processing after performing lower layer (e.g., a layer corresponding to the Ethernet address) processing. For example, upon receiving a packet affixed with Ethernet addresses of a transmission source and a transmission destination and IP addresses of the transmission source and the transmission destination, the communication unit 110 performs lower layer processing for removing the Ethernet addresses of the transmission source and the transmission destination. The communication unit 110 performs upper layer processing for outputting the packet, from which the Ethernet addresses are removed, to the application control unit 120. At this point, in the upper layer processing, in order to output information for specifying the transmission source of the packet to the application control unit 120, the communication unit 110 retrieves an Ethernet address corresponding to the IP address affixed to the packet from the lower layer address table 131.

When the communication unit 110 transmits a packet to the outside of the management apparatus 100, the communication unit 110 performs lower layer processing after performing upper layer processing. For example, after performing the upper layer processing for affixing IP addresses of a transmission source and a transmission destination to the packet, the communication unit 110 performs lower layer processing for affixing Ethernet addresses of the transmission source and the transmission destination to the packet and transmits the packet subjected to the upper layer processing ant the lower layer processing. At this point, the communication unit 110 retrieves an Ethernet address corresponding to the IP address from the lower layer address table 131.

Referring back to FIG. 2, for example, a computer program stored in a storage device on the inside is executed by a CPU (Central Processing Unit), a MPU (Micro Processing Unit), or the like using a RAM as a work area, whereby the address-management control unit 140 is realized. The address-management control unit 140 is realized by an integrated circuit such as an ASIC (Application Specific Integrated Circuit) or an FPGA (Field Programmable Gate Array). The address-management control unit 140 includes a receiving unit 141, a generating unit 142, and the transmitting unit 143.

The receiving unit 141 receives various packets via the communication unit 110. For example, the receiving unit 141 receives a packet including a control command for controlling the node 10 from the user terminal 30 and receives a packet including operation state information from the node 10.

The receiving unit 141 receives an entry notification packet from the node 10, an IP address of which changes. The entry notification packet is transmitted by multicast by the node 10.

Even when the entry notification packet transmitted by multicast is received, the management apparatus 100 does not perform processing for updating the lower layer address table 131. Therefore, at a point when the management apparatus 100 receives the entry notification packet, inconsistency occurs in the lower layer address table 131. For example, an IP address stored in the lower layer address table 131 is likely to be allocated to another node 10 different from the node 10 identified by an Ethernet address stored in association with the IP address.

In a state in which inconsistency occurs in the lower layer address table 131, even if the communication unit 110 attempts to output the entry notification packet to the application control unit 120, the communication unit 110 cannot acquire an Ethernet address corresponding to the IP address affixed to the entry notification packet from the lower layer address table 131. Therefore, the communication unit 110 cannot output an Ethernet address corresponding to a transmission source node of the entry notification packet to the application control unit 120.

Even if the management apparatus 100 (e.g., the application control unit 120) attempts to transmit some packet to the transmission source node of the entry notification packet in order to solve the inconsistency of the lower layer address table 131, the management apparatus 100 cannot acquire the Ethernet address corresponding to the transmission source node from the lower layer address table 131. Therefore, the management apparatus 100 cannot transmit the packet to the transmission source node.

Therefore, upon receiving an entry notification packet, the receiving unit 141 according to the first embodiment outputs the entry notification packet to the generating unit 142 rather than the application control unit 120.

When the receiving unit 141 receives the entry notification packet, the generating unit 142 generates a search packet for searching for a transmission source of the entry notification packet. At this point, the generating unit 142 generates, based on the entry notification packet, a search packet in which information concerning a transmission source node of the entry notification packet is set in destination information. In the first embodiment, the generating unit 142 generates a search packet in which mounted object information concerning an object mounted on the transmission source node is set in a destination object. The node 10 that receives the search packet responds to the search packet only when the node 10 is mounted with the object indicated by the mounted object information set in the destination object. The search packet can be considered as a response request packet for requesting a response from the node 10.

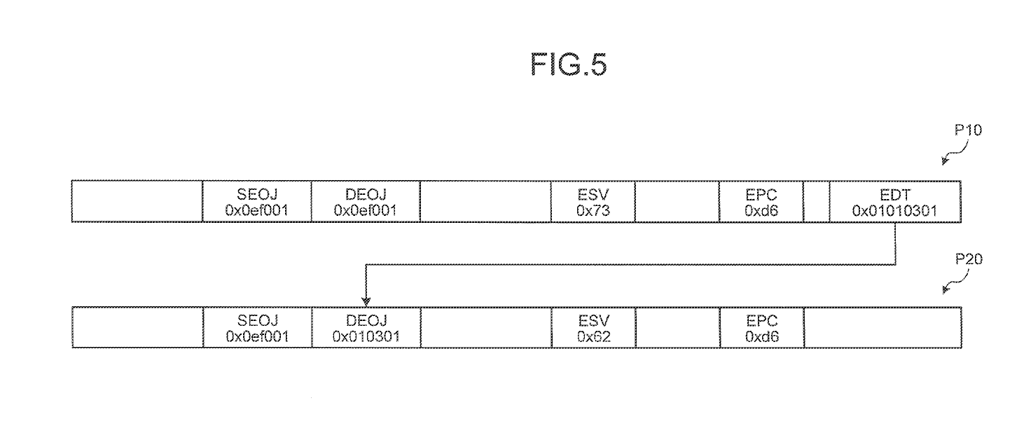

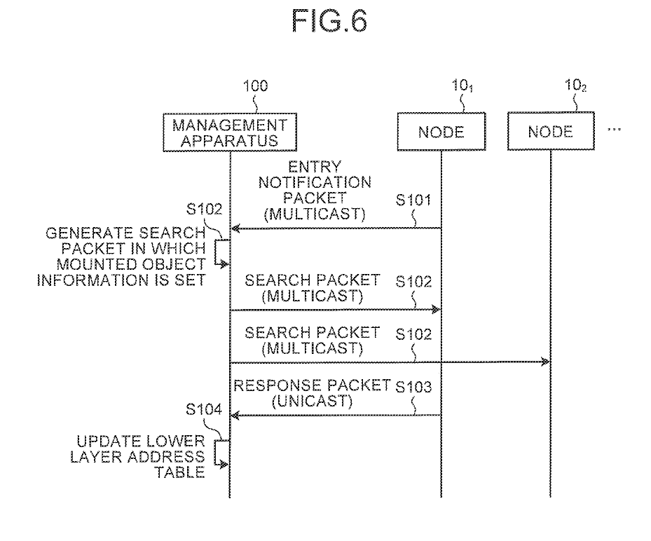

In FIG. 5, examples of an entry notification packet and a search packet according to the first embodiment are illustrated. An example of an entry notification packet P10 is illustrated in the upper part of FIG. 5. An example of a search packet P20 is illustrated in the lower part of FIG. 5.

As illustrated in the upper part of FIG. 5, the entry notification packet P10 includes items “SEOJ”, “DEOJ”, “ESV”, “EPC”, and “EDT”. “SEOJ” indicates an identifier for identifying a transmission source ECHONET object. “DEOJ” indicates an identifier for identifying a transmission destination ECHONET object. As illustrated in FIG. 5, in “SEOJ” and “DEOJ” of the entry notification packet P10, “0x0ef001” indicating a “node profile object” determined to be retained by all ECHONET objects is stored. This indicates that, in the transmission destination ECHONET object of the entry notification packet P10, all ECHONET objects in the home network system 2 (other nodes except a node that transmits the entry notification packet P10, the management apparatus 100, etc.) are designated.

“ESV” indicates an ECHONET Lite service. In “ESV” of the entry notification packet P10 illustrated in FIG. 5, “0x73” indicating a “notification of a state change” is stored. “EPC” indicates an ECHONET Lite property. “EDT” indicates a value of the ECHONET Lite property. In “EPC” of the entry notification packet P10 illustrated in FIG. 5, “0xd6” indicating an own node instance list S is stored. In “EDT” of the entry notification packet P10 illustrated in FIG. 5, “0x01013001” information indicating an air conditioner is stored as the own node instance list. In “01013001” stored in “EDT”, “01” of the start two digits indicates the number of air conditioners and “013001” indicates the air conditioner.

That is, the example illustrated in FIG. 5 indicates that a transmission source node of the entry notification packet P10 is mounted with one air conditioner. In the example illustrated in FIG. 5, one kind of information is stored in “EDT”. However, when a plurality of objects are mounted, a plurality of “EDT”s are included in the entry notification packet P10. In this way, the entry notification packet P10 includes the mounted object information indicating the object mounted on the transmission source node.

Upon receiving the entry notification packet P10, the generating unit 142 generates the search packet P20 illustrated in the lower part of FIG. 5. Specifically, as in the entry notification packet P10, the generating unit 142 sets “0x0ef001” indicating a “node profile object” in “SEOJ” of the search packet P20. On the other hand, the generating unit 142 sets, in “DEOJ” of the search packet P20, on the basis of “EDT” of the entry notification packet P10, an identifier for identifying an object mounted on the transmission source node of the entry notification packet P10 rather than “0x0ef001” indicating the “node profile object”. In this example, the generating unit 142 sets, in “DEOJ” of the search packet P20, “013001” indicating the mounted object in “01013001” set in “EDT” of the entry notification packet P10. The generating unit 142 sets, in “ESV” of the search packet P20, “0x62” indicating a readout request for a property value. The generating unit 142 sets, in “EPC” of the search packet P20, “0xd6” indicating the own node instance list S, which is an essential property of the node profile object.

The search packet generated by the generating unit 142 is not limited to the example of the search packet P20 illustrated in FIG. 5. For example, the generating unit 142 may set, in “EPC”, information indicating another essential property of the node profile object without setting “0xd6” indicating the own node instance list S.

Referring back to FIG. 2, the transmitting unit 143 transmits the search packet generated by the generating unit 142 through the communication unit 110 by multicast. A reason why the transmitting unit 143 transmits the search packet by multicast is explained. As explained above, at a point when the entry notification packet is received, inconsistency occurs in the lower layer address table 131. Therefore, even if an Ethernet address of a destination node is set in the search packet on the basis of the lower layer address table 131, the communication unit 110 and the transmitting unit 143 cannot transmit the search packet to the transmission source node of the entry notification packet. Therefore, the transmitting unit 143 transmits the search packet by multicast to transmit the search packet to all the nodes 10 conforming to the ECHONET Lite.

Consequently, the communication unit 110 receives a response packet from the node 10 that receives the search packet transmitted by the transmitting unit 143. The communication unit 110 updates the lower layer address table 131 on the basis of the received response packet. Specifically, when an object indicated by mounted object information set in “EDT” of the search packet is mounted, the node 10 that receives the search packet transmits, on the basis of setting contents of “ESV”, a response packet including a property value of the own node instance list S or the like to the management apparatus 100 by unicast. In this way, the node 10 transmits the response packet to the search packet by unicast. Therefore, the communication unit 110 can update the lower layer address table 131 on the basis of the response packet.

As explained above, the generating unit 142 generates the search packet P20 in which the object mounted on the transmission source node of the entry notification packet P10 is set in “DEOJ”. Therefore, the communication unit 110 can receive the response packet only from the node 10 mounted with the same object as the object mounted on the transmission source node of the entry notification packet P10 among the nodes 10 that receive the search packet P20. Consequently, the management apparatus 100 can prevent inconsistency from occurring in the lower layer address table 131 while preventing an increase in a network load.

Upon receiving the entry notification packet, the communication unit 110 stays on standby until a response packet to the search packet is received or stays on standby for a predetermined period in which the response packet can be received. After the lower layer address table 131 is updated, the communication unit 110 retrieves an Ethernet address corresponding to the IP address from the lower layer address table 131 and notifies the application control unit 120 of a retrieval result. Consequently, the communication unit 110 can notify the application control unit 120 of a correct set of the IP address and the Ethernet address.

Processing Procedure of the Energy Management System

A procedure of processing by the energy management system 1 is explained with reference to FIG. 6. FIG. 6 is a sequence chart illustrated the processing procedure by the energy management system 1 according to the first embodiment.

In an example illustrated in FIG. 6, the management apparatus 100 receives an entry notification packet from the node 10₁ by multicast (Act 101). In this case, the management apparatus 100 generates a search packet in which mounted object information set in the entry notification packet is set in a destination object (Act 102). The management apparatus 100 transmits the generated search packet by multicast (Act 103). The search packet transmitted by the management apparatus 100 is received by not only the node 10₁ but also another node 10₂.

In the example illustrated in FIG. 6, the node 10₁ is mounted with the object indicated by the mounted object information of the search packet. However, the node 10₂ is not mounted with the object. In this case, the node 10₁ transmits a response packet to the management apparatus 100 by unicast (Act 103). On the other hand, the node 10₂ does not transmit a response packet to the management apparatus 100. That is, in the case of the example illustrated in FIG. 6, an unnecessary response packet is not transmitted from the node 10₂ to the management apparatus 100. Therefore, it is possible to prevent a network load from increasing.

Subsequently, the management apparatus 100 receives the response packet from the node 10₁ by unicast. Therefore, the management apparatus 100 registers, on the basis of the response packet, an IP address and an Ethernet address of the node 10₁ in the lower layer address table 131 (Act 104).

### Effects of the First Embodiment

As explained above, the management apparatus 100 according to the first embodiment transmits, by multicast, the search packet P20 in which the object mounted on the transmission source node of the entry notification packet P10 is set in “DEOJ”. Therefore, it is possible to suppress the number of response packets transmitted from the node 10. As a result, with the management apparatus 100 according to the first embodiment, it is possible to prevent inconsistency from occurring in the lower layer address table 131 while preventing an increase in a network load.

### Second Embodiment

In the example explained in the first embodiment, the mounted object information is set in the destination object of the search packet. However, the “node profile object” retained by all the ECHONET objects may be set in the destination object rather than the mounted object information. In the example explained in the first embodiment, the management apparatus 100 transmits the search packet every time the management apparatus 100 receives the entry notification packet. However, the search packet may be transmitted every time a fixed period elapses. Therefore, in a second embodiment, an example is explained in which the “node profile object” is set in the destination object of the search packet and the search packet is transmitted every time a fixed period elapses. The configuration of the energy management system 1 according to the second embodiment is the same as the example illustrated in FIG. 1 except that a management apparatus 200 is included in the energy management system 1 instead of the management apparatus 100. Therefore, explanation of the configuration is omitted below.

Configuration of the Management Apparatus

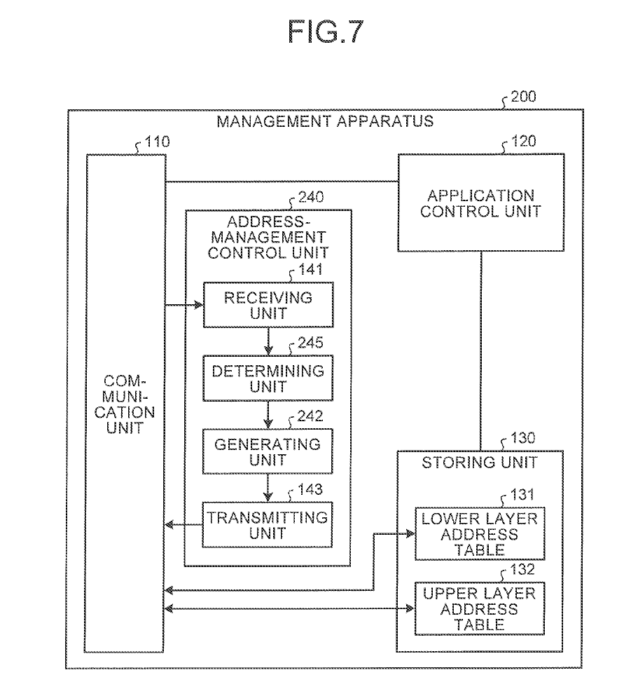

FIG. 7 is a diagram illustrating a configuration example of the management apparatus 200 according to the second embodiment. As illustrated in FIG. 7, the management apparatus 200 includes an address-management control unit 240. The address-management control unit 240 includes a determining unit 245 and a generating unit 242.

When the receiving unit 141 receives an entry notification packet, the determining unit 245 determines whether another entry notification packet is already received within a predetermined time. Specifically, as explained below, the determining unit 245 determines, using a timer, whether another entry notification packet is already received in the past by the predetermined time from the present date and time.

First, the determining unit 245 determines whether the timer is operating when the receiving unit 141 receives the entry notification packet. When the timer is not operating, the determining unit 245 determines that the entry notification packet is not already received within the predetermined time and causes the timer to operate for the predetermined time. On the other hand, when the timer is operating, the determining unit 245 determines that the entry notification packet is already received within the predetermined time and sets, in a retransmission flag, information indicating that retransmission is necessary.

When the determining unit 245 determines that the entry notification packet is not already received within the predetermined time, the generating unit 242 generates a search packet without staying on standby until the predetermined time elapses and outputs the generated search packet to the transmitting unit 143. When the determining unit 245 determines that the entry notification packet is already received within the predetermined time, the generating unit 242 generates a search packet after staying on standby until the predetermined time elapses and outputs the generated search packet to the transmitting unit 143. Specifically, after staying on standby until the timer stops, the generating unit 242 determines whether information indicating that retransmission is necessary is set in the retransmission flag. When the information indicating that the retransmission is necessary is set in the retransmission flag, the generating unit 242 clears the retransmission flag, starts the timer, and generates a search packet.

The generating unit 242 according to the second embodiment is different from the generating unit 142 according to the first embodiment. The generating unit 242 sets, in “DEW” of the search packet, “0x0ef001” indicating the “node profile object” determined to be retained by all the ECHONET objects. Therefore, the management apparatus 200 according to the second embodiment receives response packets from all the nodes 10 that receive the search packet. However, as explained below, the management apparatus 200 can prevent a network load from increasing.

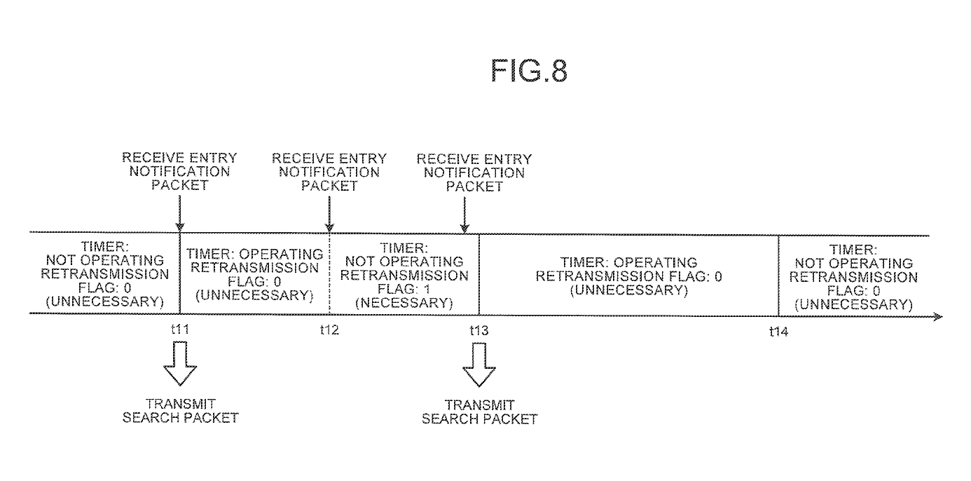

FIG. 8 is a diagram illustrating a processing example by the address-management control unit 240 according to the second embodiment. In FIG. 8, a retransmission flag in which “0” is set indicates that retransmission is unnecessary. A retransmission flag in which “1” is set indicates that retransmission is necessary.

As illustrated in FIG. 8, first, the timer is not operating and “0” is set in the retransmission flag. In this state, when the receiving unit 141 receives an entry notification packet at predetermined time t11, since the timer is not operating, the determining unit 245 causes the timer to operate. The timer operates until time t13. The generating unit 242 generates a search packet. The transmitting unit 143 transmits the search packet generated by the generating unit 242 by multicast.

Thereafter, the receiving unit 141 receives an entry notification packet at time t12 before the timer caused to operate at time t11 stops (i.e., before time t13). In this case, since the timer is operating, the determining unit 245 determines that the entry notification packet is already received within a predetermined time (an operating time of the timer) and sets “1” in the retransmission flag. At this point, since the determining unit 245 determines that the entry notification packet is already received within the predetermined time, the generating unit 242 does not generate a search packet. That is, at the point of time t12, the transmitting unit 143 does not transmit a search packet.

As illustrated in FIG. 8, the receiving unit 141 receives an entry notification packet between time t12 and time t13 as well. In this case, the determining unit 245 determines that the entry notification packet is already received within the predetermined time. The generating unit 242 does not generate a search packet. That is, the transmitting unit 143 does not transmit a search packet.

When the timer caused to operate at time t11 stops at time t13, since “1” is set in the retransmission flag, the generating unit 242 generates a search packet. At this point, the generating unit 242 causes the timer to operate and sets “0” in the retransmission flag. The transmitting unit 143 transmits the search packet generated by the generating unit 242.

Thereafter, when the receiving unit 141 does not receive an entry notification packet and the timer caused to operate at time t13 stops at time t14, the generating unit 242 and the transmitting unit 143 do not perform processing after time t13. Specifically, since an entry notification packet is not received between time t13 and time t14, the generating unit 242 does not stay on standby until the timer stops and does not generate a search packet.

As explained above, even when the entry notification packets are continuously received in a short period, the management apparatus 200 according to the second embodiment transmits the search packet at every predetermined time (operating time of the timer). Therefore, it is possible to prevent a network load from suddenly increasing. As in the example illustrated in FIG. 8, even when a plurality of entry notification packets are received in the operating time of the timer (time t11 to time t13), the management apparatus 200 only has to transmit a search packet only once after the timer stops (time t13). This is because, since the management apparatus 200 according to the second embodiment designates all the objects as destination objects, the management apparatus 200 can receive response packets from all the nodes by transmitting the search packet once. In this way, in the management apparatus 200 according to the second embodiment, as in the first embodiment, it is possible to prevent inconsistency from occurring in the lower layer address table 131 while preventing an increase in a network load.

Processing Procedure of the Management Apparatus

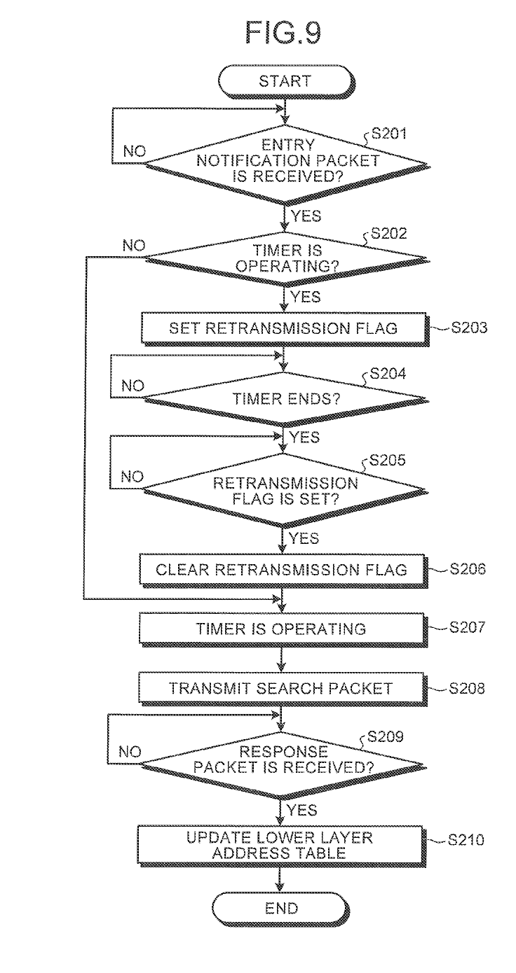

A procedure of processing by the management apparatus 200 is explained with reference to FIG. 9. FIG. 9 is a sequence chart illustrating the processing procedure by the management apparatus 200 according to the second embodiment.

As illustrated in FIG. 9, when the management apparatus 200 receives an entry notification packet (Yes in Act 201), the management apparatus 200 determines whether the timer is operating (Act 202). When the timer is operating (Yes in Act 202), the management apparatus 200 sets the retransmission flag (Act 203). In the case of the example illustrated in FIG. 8, the management apparatus 200 sets “1” in the retransmission flag.

The management apparatus 200 stays on standby until the timer stops (Act 204). When the timer stops (Yes in Act 204), the management apparatus 200 determines whether the retransmission flag is set (Act 205). When “1” or the like is set in the retransmission flag (Yes in Act 205), the management apparatus 200 clears the retransmission flag (Act 206). In the case of the example illustrated in FIG. 8, the management apparatus 200 sets “0” in the retransmission flag.

Subsequently, after causing the timer to operate (Act 207), the management apparatus 200 generates a search packet and transmits the generated search packet by multicast (Act 208). When the management apparatus 200 receives a response packet to the search packet from the node 10 (Yes in Act 209), the management apparatus 200 updates the lower layer address table 131 on the basis of the response packet (Act 210).

When the management apparatus 200 receives the entry notification packet (Yes in Act 201), if the timer is not operating (No in Act 202), the management apparatus 200 performs the processing in Acts 207 to 210.

### Effects of the Second Embodiment

As explained above, even when the entry notification packets are continuously received in a short period, the management apparatus 200 according to the second embodiment transmits the search packet at every predetermined time (operating time of the timer). Therefore, it is possible to prevent inconsistency from occurring in the lower layer address table 131 while preventing a network load from suddenly increasing. Even when a plurality of entry notification packets are received within the predetermined time (the operating time of the timer), the management apparatus 200 according to the second embodiment only has to transmit a search packet only once after the timer stops. Therefore, it is possible to prevent inconsistency from occurring in the lower layer address table 131 while preventing a network load from suddenly increasing.

### Other Embodiments

The first embodiment and the second embodiment can be combined. Specifically, the management apparatus 200 according to the second embodiment may generate a search packet in which mounted object information is set in a destination object. In this case, the management apparatus 200 transmits, at every predetermined time, by the number of received entry notification packets, a search packet in which the mounted object information set in the entry notification packet is set in a destination object. In this example, when the management apparatus 200 receives a plurality of entry notification packets within the predetermined time (within the timer operating time), the management apparatus 200 only has to transmit a search packet only once for an entry notification packet group in which the same mounted object information is set among the plurality of entry notification packets.

The configuration of the energy management system 1 in the embodiments is not limited to the example illustrated in FIG. 1. For example, the energy management system 1 does not have to include the user terminal 40 and the management server 50. For example, the home network system 2 does not have to include the user terminal 30. In this case, the management apparatus 100 displays a control screen or the like for controlling the node 10. The user controls and monitors the node 10 by operating the control screen.

In the embodiments, the lower layer address table 131 conforming to the HEMS or the ARP is explained as the example. However, the first and second embodiments can be applied to a protocol for not updating a cache-managed address table when a packet transmitted to multicast is received.

As explained above, according to the embodiments, it is possible to prevent inconsistency from occurring in the address table without increasing a network load.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A management apparatus comprising:
a storing unit configured to store, in association with an IP address of a node, identification information for identifying the node;
a receiving unit configured to receive a change notification for the IP address transmitted by multicast by the node;
a transmitting unit configured to transmit a response request packet by multicast when the receiving unit receives the change notification; and
an updating unit configured to update the storing unit on the basis of a response packet transmitted from a node that responds to the response request packet transmitted by the transmitting unit.

2. The apparatus according to claim 1, wherein the transmitting unit transmits, by multicast, the response request packet in which information concerning the node included in the change notification received by the receiving unit is set in destination information.

3. The apparatus according to claim 2, further comprising a determining unit configured to determine, when the receiving unit receives the change notification, whether the change notification is already received within a predetermined time, wherein
when the determining unit determines that the change notification is already received within the predetermined time, the transmitting unit transmits the response request packet by multicast after staying on standby until the predetermined time elapses.

4. The apparatus according to claim 3, wherein, when the determining unit determines that the change notification is not already received within the predetermined time, the transmitting unit transmits the response request packet by multicast without staying on standby until the predetermined time elapses.

5. The apparatus according to claim 3, wherein, when the receiving unit receives the change notification a plurality of times within a predetermined time, the transmitting unit transmits the response request packet only once after staying on standby until the predetermined time elapses.

6. The apparatus according to claim 1, further comprising a determining unit configured to determine, when the receiving unit receives the change notification, whether the change notification is already received within a predetermined time, wherein
when the determining unit determines that the change notification is already received within the predetermined time, the transmitting unit transmits the response request packet by multicast after staying on standby until the predetermined time elapses.

7. The apparatus according to claim 6, wherein, when the determining unit determines that the change notification is not already received within the predetermined time, the transmitting unit transmits the response request packet by multicast without staying on standby until the predetermined time elapses.

8. The apparatus according to claim 6, wherein, when the receiving unit receives the change notification a plurality of times within a predetermined time, the transmitting unit transmits the response request packet only once after staying on standby until the predetermined time elapses.

9. An address management method executed by a management apparatus, the address management method comprising:
receiving a change notification for an IP address transmitted by multicast by a node;
transmitting, when the change notification is received, a response request packet by multicast; and
storing, on the basis of a response packet transmitted from the node that responds to the transmitted response request packet, in association with an IP address of the node, identification information for identifying the node.

10. The method according to claim 9, further comprising transmitting, by multicast, the response request packet in which information concerning the node included in the received change notification is set in destination information.

11. The method according to claim 10, further comprising:
determining, when the change notification is received, whether the change notification is already received within a predetermined time; and
transmitting, when it is determined that the change notification is already received within the predetermined time, the response request packet by multicast after staying on standby until the predetermined time elapses.

12. The method according to claim 11, further comprising transmitting, when it is determined that the change notification is not already received within the predetermined time, the response request packet by multicast without staying on standby until the predetermined time elapses.

13. The method according to claim 11, further comprising transmitting, when the change notification is received a plurality of times within a predetermined time, the response request packet only once after staying on standby until the predetermined time elapses.

14. The method according to claim 9, further comprising:
determining, when the change notification is received, whether the change notification is already received within a predetermined time; and
transmitting, when it is determined that the change notification is already received within the predetermined time, the response request packet by multicast after staying on standby until the predetermined time elapses.

15. The method according to claim 14, further comprising transmitting, when it is determined that the change notification is not already received within the predetermined time, the response request packet by multicast without staying on standby until the predetermined time elapses.

16. The method according to claim 14, further comprising transmitting, when the change notification is received a plurality of times within the predetermined time, the response request packet only once after staying on standby until the predetermined time elapses.
